(19) United States
(12) Patent Application Publication
(10) Pub. No.: US 2025/0050710 A1
(43) Pub. Date: Feb. 13, 2025

(54) ELECTRIC RADIATOR OF A HEATING, VENTILATION AND/OR AIR-CONDITIONING SYSTEM

(71) Applicant: VALEO SYSTEMES THERMIQUES, La Verriere (FR)

(72) Inventors: Romain DELCOURT, La Verriere (FR); Erwan Gogmos, La Verriere (FR); Laurent TELLIER, La Verriere (FR); Yann COUAPEL, La Verriere (FR); Jonathan FOURNIER, La Verriere (FR); Serif KARAASLAN, La Verriere (FR); Jonathan LEFLOCH, La Verriere (FR)

(73) Assignee: VALEO SYSTEMES THERMIQUES, La Verriere (FR)

(21) Appl. No.: 18/719,548

(22) PCT Filed: Dec. 6, 2022
(86) PCT No.: PCT/EP2022/084625

§ 371 Date: Jun. 13, 2024

(30) Foreign Application Priority Data
Dec. 13, 2021 (FR) 2113348

(51) Int. Cl. B60H 1/22

(52) U.S. Cl. CPC B60H 1/2225; B60H 2001/2278; B60H 2001/2287

(57) ABSTRACT

The invention relates to an electric radiator fitted with at least one heating element and an electronic control unit, the at least one heating element extending principally in a longitudinal direction and having a longitudinal end facing the electronic control unit, the at least one heating element including several resistive elements and plates forming electrodes. Each plate of the at least one heating element is configured to have a connection component at one longitudinal end for the electrical connection of the plate to the electronic control unit, at least one of these connection components being disposed at each of the longitudinal ends of this heating element.

### TECHNICAL FIELD

The present invention pertains to the field of heating, ventilation and/or air-conditioning systems for motor vehicles, and it more specifically relates to an electric radiator for such heating, ventilation and/or air-conditioning systems.

### BACKGROUND OF THE INVENTION

Motor vehicles are generally provided with a heating, ventilation and/or air-conditioning system that makes it possible to circulate an air flow toward the passenger compartment of the motor vehicle and, depending on the temperature of the passenger compartment desired by the driver and/or passengers of the motor vehicle, to heat and/or cool the air flow sent to the passenger compartment. Such heating, ventilation and/or air-conditioning systems thus comprise at least one member for circulating the air flow and an electric radiator capable of heating the air flow circulated toward the passenger compartment.

It is known for the electric radiators of these heating, ventilation and/or air-conditioning systems to comprise a heating body, in which heating elements, for example, in the form of tubes, are disposed next to each other across an air flow to be heated. Such electric radiators generally comprise at least one electronic control device for the heating elements comprising a printed circuit board, on which various electronic components are installed. The electronic components participate in generating a control instruction to be transmitted to the heating elements to heat up. As a result, the temperature of the heating elements can increase and the air flow circulating between the heating elements of the electric radiator is heated as it circulates between the heating elements.

The heating elements are connected to the printed circuit board, where appropriate by transistors fastened to the printed circuit board, so that the control instructions can be transmitted to the heating elements.

By being fastened to the printed circuit board in this way, the heating elements extend principally in a direction perpendicular to a plane of extension of the printed circuit board. In this arrangement, each heating element is connected to the printed circuit board at one of its longitudinal ends, namely the one closest to the printed circuit board, and all the resistive elements within the heating elements are powered by the same electric current passing through this connection, so that a substantially uniform amount of heat is released over the entire main extension dimension of the heating element.

### SUMMARY OF THE INVENTION

The intention can be to configure the heating body so as to be able to split it into several particular heating zones. In other words, the intention can be to supply electrical current to the resistive elements present in a first zone of the heating body, in order to heat part of the air flow caused to pass through this heating body, and to simultaneously leave other resistive elements inactive so as to avoid expending electrical energy while the part of the air flow caused to encounter these other resistive elements does not have to be heated.

The arrangement of the aforementioned heating elements involves even heat distribution within the same heating element so that separating the heating body into several selectively activatable heating zones can only be achieved by selectively turning on the heating elements, and therefore only in a side-by-side direction of the heating elements, parallel to the plane of extension of the printed circuit board.

The present invention proposes an alternative solution to the solutions that already exist and primarily relates to a novel arrangement of the electrical connections of the heating elements that enables a different distribution of the selectively activatable heating zones and that can enable a multiplication of the selectively activatable heating zones in different directions.

In this context, the present invention principally relates to an electric radiator of a heating, ventilation and/or air-conditioning system, the electric radiator comprising at least one heating body fitted with at least one heating element, the electric radiator comprising at least one electronic control unit configured to power and control the operation of the at least one heating element and a housing in which the electronic control unit is seated, the heating body being fastened to the housing, the housing comprising a back wall facing the heating body extending in a main plane of extension, the at least one heating element of the heating body extending perpendicularly to the main plane of extension of the back wall and principally in a longitudinal direction having a first longitudinal end facing the electronic control unit and an opposite second longitudinal end, the at least one heating element comprising several resistive elements and plates forming electrodes, the resistive elements being framed by the plates, characterized in that each plate of the at least one heating element is configured to have a connection component at one longitudinal end of this heating element for the electrical connection of said plate to the electronic control unit, at least one of these connection components being disposed at each of the longitudinal ends of this heating element.

The plates forming electrodes are disposed on either side of the resistive elements, clamping said elements. The connection component for connecting a plate is configured to be at least electrically connected to the printed circuit board of the electronic control unit via a connection means. Advantageously, a connection means is common to several connection components, and more specifically to connection components respectively associated with one heating element of the heating body. Where the heating body includes a plurality of heating elements arranged beside one another, the heating elements are configured and disposed in relation to one another so that several connection components are aligned in the stacking direction of the heating elements.

The plates are then understood to be powered via the connection component thereof. The disposition of the connection components at opposite longitudinal ends notably enables at least two different plates to be powered in a single heating element, thereby defining two heating zones powered independently of one another and that can therefore be activated selectively, independently of one another.

According to an optional feature of the invention, the heating element comprises at least a first plate that extends over the entire length of the heating element, the heating element comprising a second plate and a third plate each extending over a portion of the heating element and being disposed on the other side of the resistive elements in relation to the first plate, the connection component of the second plate extending at one of the longitudinal ends of the heating element whereas the connection component of the third plate extends at the other of the longitudinal ends of the heating element.

The electronic control unit is configured to transmit control instructions, and notably electrical power supply instructions, specific to the second plate or the third plate via the connection components thereof, which then results in the specific heating of the resistive elements disposed between the second plate and the first plate or the resistive elements disposed between the third plate and the first plate. These control instructions can be similar or different so that the heating of the resistive elements of a single heating element can be similar or different, thereby forming selectively activatable heating spaces within the heating element.

According to another optional feature of the invention, the connection component of the second plate is disposed at the first longitudinal end of the heating element, the connection component of the third plate being disposed at the second longitudinal end of the heating element. In other words, the connection component of the second plate faces the electronic control unit, whereas the connection component of the third plate extends at the opposite end from the electronic control unit.

According to another optional feature of the invention, The connection component of the first plate and the connection component of the second plate are disposed at the same longitudinal end of the heating element. More specifically, the connection component of the first plate and the connection component of the second plate face the electronic control unit.

According to another optional feature of the invention, the heating element comprises a front edge and a rear edge, the connection component of the first plate being disposed closer to one of the front or rear edges, whereas the connection component of the second plate is disposed closer to the other edge.

More specifically, the electric radiator is configured and positioned inside a heating, ventilation and/or air-conditioning system so that the heating body has a front face and a rear face with the air flow to be heated circulating mainly transversely from the front face toward the rear face. In this context, it should be noted that the front edge of a heating element of the heating body is oriented toward the front face of the heating body and that the rear face of this same heating element is oriented toward the rear face of the heating body.

According to another optional feature of the invention, the connection component of the first plate and the connection component of the second plate extend from the opposite transverse edges of the heating element, these transverse edges being perpendicular to the front and rear edges of the heating element.

As a result of the foregoing, the connection components extending from the same longitudinal end of the heating element can be offset in relation to one another both transversely and vertically, i.e. in the two directions perpendicular to the main longitudinal direction of the heating element.

According to another optional feature of the invention, the connection component of the third plate is centered between the front edge and the rear edge of the heating element. This means that the connection component of the third plate is the same distance away from the front edge and the rear edge.

According to another optional feature of the invention, at least one of the connection components comprises a first portion extending in a plane parallel to a main plane of extension of the heating element and at least a second portion extending in a plane intersecting the main plane of extension of the heating element. In other words, the connection component is elbow-shaped, notably to include a second portion remote from the heating element that is substantially perpendicular to the main plane of extension of the heating element and that thus provides a fastening plane perpendicular to the heating element for a connection means common to the connection components of different heating elements.

According to an optional feature of the invention, the first portions of the connection components of the first plate and of the second plate extend over a substantially equal longitudinal dimension from one connection component to the other, so that the second portions of the connection components of the first plate and of the second plate extend substantially in the same plane.

According to an optional feature of the invention, the first portions of the connection components of the first plates, and respectively of the second plates, of each heating element extend over a substantially equal longitudinal dimension from one heating element to the other, so that the second portions of the connection components of the first plates, and respectively of the second plates, of different heating elements extend substantially in the same plane. This means that the same connection means in the form of a substantially rectilinear bar can connect each of the second portions of the connection components of the first plates in the heating body and the same connection means in the form of a substantially rectilinear bar can connect each of the second portions of the connection components of the second plates in the heating body.

According to another optional feature of the invention, each connection component comprises a first portion extending one of the transverse edges of the corresponding heating element, extending parallel to the longitudinal direction, and a second portion extending substantially perpendicularly to the first portion, the second portion being oriented toward the transverse edge of the heating element opposite to that extended by the first portion of this connection component. In other words, each connection component has a specific shape, notably an elbow shape, oriented such as to at least partially cover the corresponding longitudinal end of the heating element. This limits the transverse size of a heating element and facilitates connection of the heating elements within a reduced footprint.

According to another optional feature of the invention, the electric radiator comprises at least one connection assembly configured to electrically connect at least one connection component of a plate to the electronic control unit, the connection assembly comprising at least a first connection branch extending parallel to the back wall of the housing and facing the first longitudinal end of at least one heating element and at least one other connection branch extending parallel to the back wall of the housing and facing the second longitudinal end of at least one heating element. In this configuration, the branches extend parallel to each other, each at one of the longitudinal ends of the heating elements. More specifically, it is notable here that the branches extend away from the electronic control unit in relation to the heating body.

According to another optional feature of the invention, the at least one first connection branch is disposed between the electronic control unit and the first longitudinal ends of the heating elements and is configured to electrically connect the connection components of the first plates to said electronic control unit.

According to another optional feature of the invention, the first connection branch is in contact with the connection components of the first plates of all of the heating elements.

According to another optional feature of the invention, the connection assembly comprises a second connection branch extending between the electronic control unit and the first longitudinal ends of the heating elements parallel to the first connection branch, the second connection branch being configured to electrically connect the connection components of the second plates to the electronic control unit.

According to another optional feature of the invention, the second connection branch is in contact with the connection components of the second plates of all of the heating elements.

According to another optional feature of the invention, the other connection branch consists of a third connection branch including a first portion extending from the electronic control unit, parallel to the heating elements, to the second longitudinal end of the heating elements and a second portion extending parallel to the first connection branch and facing the second longitudinal end of one of the heating elements to electrically connect the connection components of the third plates to the electronic control unit.

According to another optional feature of the invention, the third connection branch is in contact with the connection components of the third plates of all of the heating elements.

According to another optional feature of the invention, the heating elements are split into at least two heating assemblies, the electric radiator comprising a connection assembly for each of the heating assemblies.

According to another optional feature of the invention, each heating assembly comprises a first connection branch, a second connection branch and a third connection branch as described above and a connection end piece cooperating with the three connection branches to electrically connect said connection branches to the electronic control unit.

According to another optional feature of the invention, a first connection branch of a first connection assembly is in contact with the connection components of the first plates of the heating elements of the first heating assembly.

According to another optional feature of the invention, a second connection branch of a first connection assembly is in contact with the connection components of the second plates of the heating elements of the first heating assembly.

According to another optional feature of the invention, a third connection branch of a first connection assembly is in contact with the connection components of the third plates of the heating elements of the first heating assembly.

According to another optional feature of the invention, a first connection branch of a second connection assembly is in contact with the connection components of the first plates of the heating elements of the second heating assembly.

According to another optional feature of the invention, a second connection branch of a second connection assembly is in contact with the connection components of the second plates of the heating elements of the second heating assembly.

According to another optional feature of the invention, a third connection branch of a second connection assembly is in contact with the connection components of the third plates of the heating elements of the second heating assembly.

In this arrangement and as set out in greater detail below, the first heating assembly can correspond to a first set of heating elements and the second heating assembly can correspond to a second set of heating elements. The electronic control unit is able to transmit a first control instruction to the first set of heating elements and a second control instruction to the second set of heating elements, and the control instructions can therefore be similar to or different from each other. This means that the first set of heating elements can be heated in a similar manner to or in a distinct manner from the second set of heating elements, thus generating two additional heating zones that are distinct from one another.

According to another optional feature of the invention, the heating element comprises at least a first plate that extends over a first portion of the heating element, the heating element comprising a second plate and a third plate each extending over a second portion of the heating element, the heating element comprising a fourth plate that extends over the first portion parallel to the first plate, each plate being distinct from the other plates, the connection components of the first plate and of the second plate extending at one of the longitudinal ends of the heating element whereas the connection components of the third plate and of the fourth plate extend at the other of the longitudinal ends of the heating element.

According to another optional feature of the invention, the connection component of the first plate and the connection component of the second plate are disposed at the first longitudinal end of the heating element, whereas the connection component of the third plate and the connection component of the fourth plate are disposed at the second longitudinal end of the heating element.

According to another optional feature of the invention, at least one of the resistive elements comprises a PTC stone.

A further aim of the present invention is a heating, ventilation and/or air-conditioning system, comprising at least one ventilation device able to force an air flow to circulate through the heating, ventilation and/or air-conditioning system and an electric radiator according to any one of the preceding features and through which the air flow is heated.

According to another optional feature of the invention, the heating, ventilation and/or air-conditioning system comprises at least two heating ducts, with one of the ducts guiding at least some of the air flow toward a first heating zone of the electric radiator, the other duct guiding at least some of the air flow toward another heating zone of the electric radiator, the first heating zone being defined longitudinally at least partially by the second plate, whereas the second heating zone is at least partially defined longitudinally by the third plate.

According to another optional feature of the invention, the heating, ventilation and/or air-conditioning system comprises at least several heating ducts, with each of the ducts guiding at least some of the air flow toward a heating zone of the electric radiator, each heating zone being defined firstly by the arrangement of the first, second, third and fourth plates, and secondly by the arrangement of the heating assemblies of the heating body.

### BRIEF DESCRIPTION OF DRAWINGS

Further features, details and advantages of the invention will become more clearly apparent from reading the following description on the one hand, and on the other hand a number of exemplary embodiments given by way of non-limiting illustration, with reference to the appended schematic drawings, in which:

FIG. 1 is a perspective view of an electric radiator according to the invention;

FIG. 2 is a front view of a first embodiment of a heating body and of an electronic control unit of the electric radiator shown in FIG. 1;

FIG. 3 is a detailed perspective view of a connection between a first longitudinal end of heating elements and the electronic control unit of the electric radiator shown in FIG. 1;

FIG. 4 is a detailed perspective view of a connection between a second longitudinal end of heating elements and the electronic control unit of the electric radiator shown in FIG. 1;

FIG. 5 is a perspective view of two opposing faces of a heating element of the electric radiator shown in FIG. 1, the heating element comprising three plates;

FIG. 6 is a view similar to the view in FIG. 5, showing in perspective two opposing faces of a heating element, in this case comprising four plates;

FIG. 7 is a front view of a second embodiment of a heating body and of an electronic control unit of the electric radiator shown in FIG. 1; and

FIG. 8 is a front view of a third embodiment of a heating body and of an electronic control unit of the electric radiator shown in FIG. 1.

### DETAILED DESCRIPTION OF THE INVENTION

The features, variants and various embodiments of the invention can be combined with one another, in various combinations, provided that they are not mutually incompatible or mutually exclusive. In particular, it is possible to envisage variants of the invention that comprise only a selection of features described below, independently of the other features described, if this selection of features is sufficient to confer a technical advantage and/or to differentiate the invention from the prior art.

In the figures, elements that are common to multiple figures retain the same reference sign.

In the following detailed description, the terms “longitudinal”, “transverse” and “vertical” refer to the orientation of an electric radiator according to the invention. A longitudinal direction corresponds to a main direction of elongation of a heating element of the electric radiator, with this longitudinal direction being parallel to a longitudinal axis L of an L, V, T coordinate system illustrated in the figures. A transverse direction corresponds to a direction in which a connection branch of a connection assembly of the electric radiator mainly extends, this transverse direction being parallel to a transverse axis T of the coordinate system L, V, T, and this transverse axis T being perpendicular to the longitudinal axis L. Finally, a vertical direction corresponds to a direction parallel to a vertical axis V of the coordinate system L, V, T, this vertical axis V being perpendicular to the longitudinal axis L and the transverse axis T.

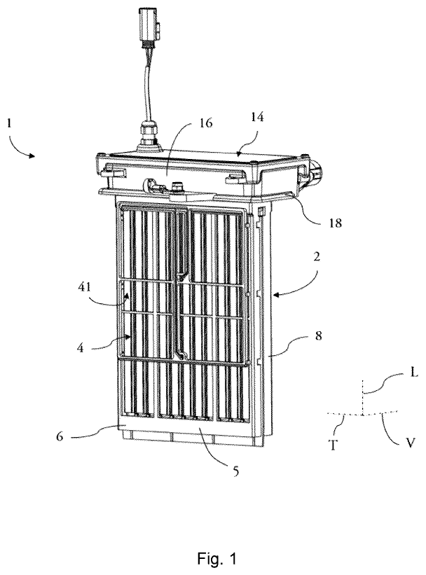

FIG. 1 illustrates an electric radiator 1 according to the invention, configured to be installed in a heating, ventilation and/or air-conditioning system of a vehicle. The electric radiator 1 is used in this type of system, for example to heat an air flow circulating in the heating, and/or air-conditioning system through said electric radiator 1.

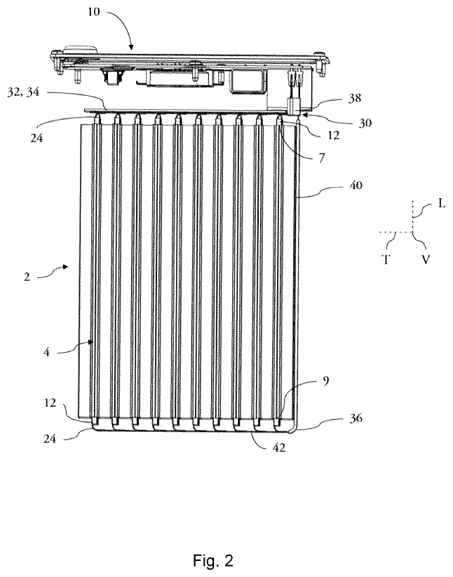

To this end and as can be seen in FIGS. 1 and 2, the electric radiator 1 comprises at least one heating body 2 fitted with at least one heating element 4, and in this case a plurality of heating elements 4 arranged next to one another so as to together delimit a space for circulating an air flow to be heated. More specifically, each heating element 4 is disposed at a distance from at least one neighboring heating element 4, with an air flow being able to circulate between these two heating elements 4 to be heated. In the remainder of the description

The heating body 2 has a front face and a rear face so that the air flow to be heated mainly flows transversely from the front face toward the rear face of the heating body 2. The heating elements 4 of the heating body 2 thus each have a front edge 41 oriented toward the front face of the heating body 2 and a rear edge 43 oriented toward the rear face of the heating body 2.

As is more particularly visible in FIG. 1, the heating body 2 comprises a support 6 for the heating elements 4, with the support 6 comprising at least side walls 8 that delimit the heating body 2 transversely and that face one of the heating elements 4, and a transverse closing wall 5. More specifically, the heating elements 4 are disposed beside one another in the transverse direction T and the two side walls 8 extend longitudinally at a constant distance from one of the two heating elements disposed transversely at the end of the row.

A first longitudinal end 7 of the heating elements 4 and a second longitudinal end 9 are also defined, the first longitudinal end 7 facing the electronic control unit 10, whereas the second longitudinal end 9 is disposed at the opposite end from this electronic control unit 10.

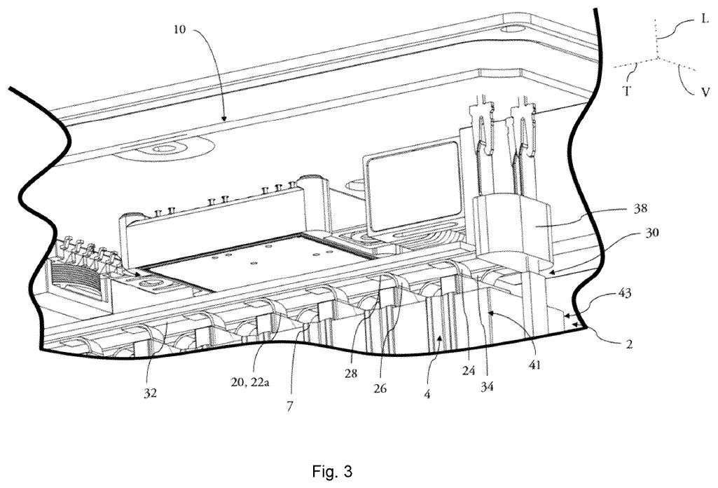

The electric radiator 1 comprises an electronic control unit 10 that is configured to transmit a control instruction to at least one heating element 4 to heat up, the electronic control unit 10 being more particularly visible in FIGS. 2 and 3. More specifically, the electronic control unit 10 can generate an instruction to electrically power the resistive elements 12 included in this heating element 4, in order to increase the temperature thereof, with this heating element 4 then transferring calories to the air flow conveyed through the heating body 2 to heat the latter. To this end, and as described in greater detail below, each heating element includes at least one electrical connection component that is electrically connected to electronic components in the electronic control unit 10.

As can be seen in FIGS. 1 and 2, the electric radiator 1 comprises a housing 14 in which the electronic control unit 10 is seated and protected, the housing 14 limiting the heat exchanges and the electromagnetic disturbances with the environment outside the electric radiator 1. The housing 14 comprises several walls defining an internal volume, in which the electronic control unit 10 is installed, the housing 14 advantageously being a parallelepiped.

The housing 14 notably comprises side walls 16 that peripherally delimit the seat of the electronic control unit 10, and a back wall 18 facing the heating body 2 that participates in delimiting the internal volume of the housing 14 and that separates this internal volume from the heating body 2 of the electric radiator 1. The back wall 18 can also be considered to be a component of the support 6 of the heating body 2 when the support 6 is rigidly connected to the housing 14 by suitable attachment means. In other words, the back wall 18 is interposed between the electronic control unit 10 and one of the heating elements 4 of the heating body 2.

The back wall 18 extends in a main plane of extension, in this case transverse and vertical, that is perpendicular to the side walls 8 of the support 6 of the heating body 2.

The heating elements 4 of the heating body 2 extend principally in a longitudinal direction L perpendicularly to the main plane of extension of the back wall 18. In other words, the heating elements 4 extend parallel to one another and perpendicular to the back wall 18 of the housing 14. The heating elements 4 are disposed beside one other in a stacking direction parallel to the main plane of extension of the back wall 18, the stacking direction in this case being parallel to the transverse direction T. As mentioned above, the side walls 8 are disposed at each transverse end of this stack of heating elements.

According to the invention, with the heating elements 4 parallel to one another, the heating elements 4 are in indirect contact with the electronic components seated in the housing 14, i.e. at least one additional electrical connection component is disposed between the heating elements 4 and electrical connection component 24 thereof and the electronic components seated in the housing 14 that participate in generating and transmitting the control instructions to the heating elements 4.

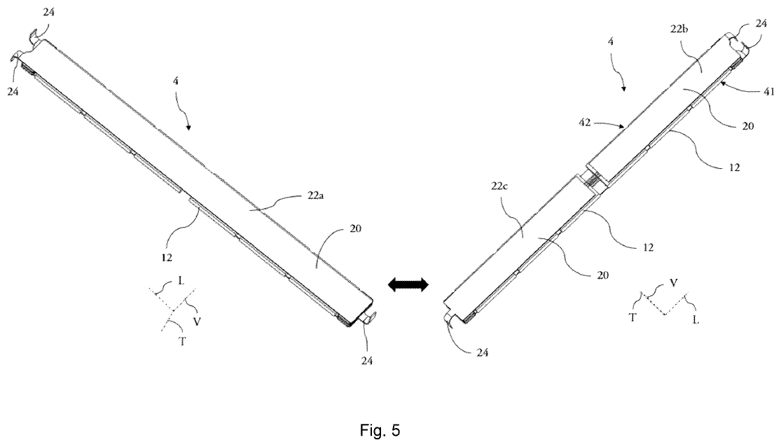

According to the invention and as illustrated in FIG. 5, at least one heating element 4 of the heating body 2 comprises resistive elements 12 and plates 20 forming electrodes, advantageously disposed in a tube, each of the plates 20 being extended longitudinally at one of the longitudinal ends thereof by a connection component 24, as mentioned above, that enables the corresponding plate 20 to be connected to the electronic control unit 10 of the electric radiator 1. The resistive elements 12 can notably be PTC stones, these resistive elements being interposed between two of the plates 20, each forming an electrode able to conduct an electric current to the resistive elements 12 and to increase the temperature thereof to transfer these calories to the air flow conveyed through the heating body 2.

According to one feature of the invention, the heating element 4 comprises a first plate 22a, a second plate 22b, and at least one third plate 22c.

The first plate 22a extends over the entire length of the heating element 4, in a first plane and on one side of the resistive elements 12, whereas the second plate 22b and the third plate 22c each extend over a portion of the heating element 4 on the other side of the resistive elements 12 and in a second plane of extension distinct from and parallel to the first plane forming the main plane of elongation of the first plate 22a.

The resistive elements 12 are disposed between the first plane of the first plate 22a and the second plane of the second and third plates 22b, 22c. On account of the size of the second and third plates 22b, 22c, each resistive element 12 is disposed between the first plate 22a and one or other of the second or third plates 22b, 22c. In other words, the resistive elements 12 are sandwiched between the first plate 22a on one side and either the second plate 22b or the third plate 22c on the other side.

The second and third plates 22b, 22c are connected electrically to the electronic control unit 10 so as to form electrodes respectively associated with some of the resistive elements 12 of the same heating element 4 and the first plate 22a is connected electrically to the electronic control unit 10 to form an electrode common to each resistive element 12 of the same heating element 4. This means that supplying electrical power to the second plate 22b only heats the resistive elements 12 disposed between the second plate 22b and the first plate 22a, whereas supplying electrical power to the third plate 22c only heats the resistive elements 12 disposed between the third plate 22c and the first plate 22a. Selectively controlling the power supply to the second or third plate 22b, 22c makes it possible to define two heating spaces that are distinct from one another within the same heating element 4, thereby defining, where each of the heating elements 4 includes such a segmentation and on account of the longitudinal arrangement of each of the heating elements, two distinct heating spaces in the longitudinal direction L inside the heating body 2.

As mentioned above, each of the plates 20 is extended longitudinally at one of the longitudinal ends thereof by a connection component 24.

Each connection component 24 comprises a first portion 26 extending in a plane parallel to a main plane of extension of the heating element 4 and at least a second portion 28 extending in a plane intersecting the main plane of extension of the heating element 4. In other words, the connection component 24 is elbow-shaped with a portion extending in a plane parallel to the main plane of extension of the heating element 4 and another portion extending in a different plane, and notably in a plane substantially perpendicular to this main plane of extension of the heating element 4.

The second plate 22b and the third plate 22c are arranged in relation to one another, in the common main plane of elongation thereof, such that the longitudinal end of the second plate 22b that bears the connection component 24 is the longitudinal end disposed at the opposite end from the third plate 22c, and such that the longitudinal end of the third plate 22c that bears the connection component 24 is the longitudinal end disposed at the opposite end from the second plate 22b.

This means that, according to the invention, the heating element 4 is configured such as to have at least one connection component 24 of a plate 20 at each of the longitudinal ends 7, 9 thereof.

Like the other plates 20, the first plate 22a comprises just one connection component 24, which can therefore be disposed at either of the longitudinal ends of the heating element 4. In the example illustrated, the connection component 24 of the first plate 22a is disposed at the same longitudinal end of the heating element 4 as the connection component 24 of the second plate 22b, so that the connection component 24 of the first plate 22a and the connection component 24 of the second plate 22b are disposed at the same longitudinal end 7 of the heating element 4, whereas the connection component 24 of the third plate 22c is disposed at the opposite longitudinal end 9 of the heating element 4.

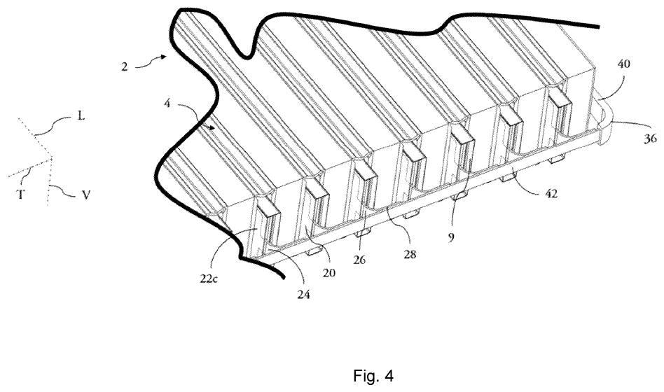

In this context and as is more particularly visible in FIGS. 4 and 5, the connection component 24 of the third plate 22c is centered between the front edge 41 and the rear edge 43 of the heating element 4, at the corresponding longitudinal end. In other words, the connection component 24 of the third plate 22c is the same distance away from the front edge and the rear edge of the heating element 4.

As shown for example in FIGS. 3 and 5, the connection components 24 intended to project from the same longitudinal end of the heating element 4, i.e. in this case the connection components associated with the first and second plates, are configured such that the first portion of one of the connection components, in this case the connection component associated with the first plate 22a, is close to the front edge 41, and the first portion of the other connection component, in this case the connection component associated with the second plate 22b, is close to the rear edge 43.

Furthermore, the second portions 28 of the connection components 24 of the first plate 22a and of the second plate 22b extend parallel to one another, as mentioned above. According to the invention, the second portions 28 of the connection components 24 of the first plate 22a and of the second plate 22b extends toward one another in the transverse direction T. This means that, for a given heating element, the second portions of the connection components 24 of the first plate 22a and of the second plate 22b extend parallel and principally in the transverse direction T, toward one another, in opposite directions. For a given heating element, the connection component 24 associated with the first plate 22a or with the second plate 22b can include a first portion 26 that extends from a first transverse edge of the corresponding heating element and a second portion that extends toward the opposite second transverse edge of this heating element, and the connection component 24 of the other plate of the first plate 22a and the second plate 22b of this heating element can mirror this layout, with the first portion extending from the second transverse edge and the second portion extending toward the first transverse edge.

As shown notably in FIG. 3, this means that the connection component 24 of the first plate 22a and the connection component 24 of the second plate 22b at least partially cover the corresponding longitudinal end of the heating element 4, notably via the second portion 28 of these connection components.

Furthermore and as shown notably in FIG. 2, between two heating elements of the heating body, the first portions of the connection components of each first plate, and respectively of each second plate, extend over a substantially equal longitudinal dimension, so that the second portions of the connection components in question extend substantially in the same plane and can be connected to the same connection means.

In the example illustrated, the connection component 24 of the first plate 22a and the connection component 24 of the second plate 22b are disposed at the first longitudinal end 7 of the heating element 4, whereas the connection component 24 of the third plate 22c is disposed at the second longitudinal end 9 of the heating element 4. The connection components 24 of the first plates 22a and of the second plates 22b therefore face the electronic control unit 10 and the connection component 24 of the third plate 22c extends in the longitudinal direction L at the opposite end from the electronic control unit 10.

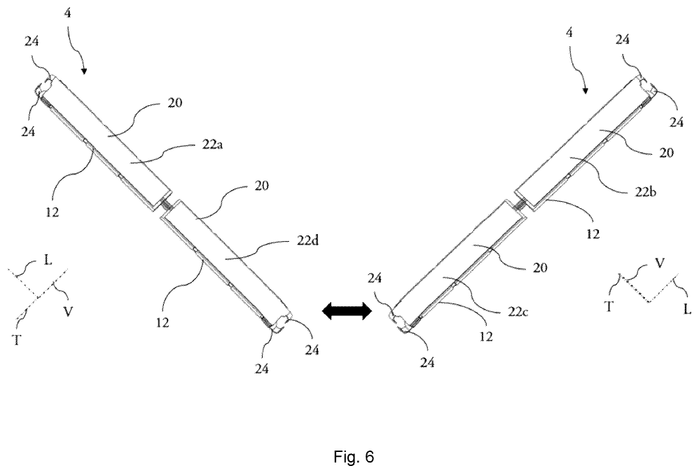

According to an alternative embodiment of the invention shown in FIG. 6, the heating element 4 comprises four plates 20, each having a connection component 24, so that two connection components are disposed at each of the longitudinal ends 7, 9 of the heating element 4. In this embodiment, one of the faces of the resistive elements 12 is covered by the second plate 22b and the third plate 22c, the other face of the resistive elements 12 being covered by the first plate 22a and a fourth plate 22d. In this context, the first plate 22a only extends over one portion of the heating element 4, whereas the fourth plate 22d extends over the other portion.

In this particular arrangement, the connection components 24 of the first plate 22a and of the second plate 22b are disposed at the same longitudinal end, in this case the first longitudinal end 7, of the heating elements 4, the connection components 24 of the third plate 22c and of the fourth plate 22d being disposed at the same longitudinal end, in this case the second longitudinal end 9, of the heating elements 4.

Furthermore, in this specific embodiment, the resistive elements 12 are framed either by the first plate 22a and the second plate 22b, or by the third plate 22c and the fourth plate 22d. This specific arrangement of the four plates 20 in relation to the resistive elements 12 optimizes the assembly of the different components of the heating element 4 in relation to one another, as well as the assembly of the heating elements 4 within the heating body 2 itself.

As illustrated in FIG. 2, the connection components 24 of each of the plates 20 are configured to be connected to the electronic control unit 10 using simple connection means.

According to the invention, the electric radiator 1 comprises at least one connection assembly 30 configured to electrically connect at least one connection component 24 of a plate 20 to the electronic control unit 10. The connection assembly 30 makes the electrical connection between the connection component 24, and therefore one of the plates 20, and the electronic control unit 10. This connection assembly 30 enables the electronic control unit 10 to transmit control instructions to the plate 20 to enable the temperature of the resistive elements 12 to be increased or otherwise as a function of the temperature to be reached by the air flow passing through the heating body 2 of the electric radiator 1.

According to the invention, the connection assembly 30 comprises at least a first connection branch 32 extending parallel to the back wall of the housing 14, between this back wall and the first longitudinal end 7 of the heating elements 4 to be connected via this first connection branch, and at least one other connection branch 36 also extending parallel to the back wall of the housing 14, passing between the transverse closing wall 5 and the second longitudinal end 9 of at least one heating element 4, the connection assembly 30 comprising a connection end piece 38 linking the connection branches to the electronic control unit 10. This means that the connection branches 32, 36 make the electrical connection between the connection components 24 and the connection end piece 38, the latter making the electrical connection between the connection branches 32, 36 and the electronic control unit 10.

Advantageously, the connection branches 32, 36 extend parallel to one another, each facing one of the longitudinal ends 7, 9 of the heating elements 4, and therefore on both sides of the heating body. This means that the connection branches 32, 36 each have at least one portion that extends in the transverse direction T, passing through one or other of the longitudinal ends 7, 9 of the heating elements 4.

More specifically, the at least one first connection branch 32 is disposed between the electronic control unit 10 and the first longitudinal ends 7 of the heating elements 4 and is configured to electrically connect the connection components 24 of the first plates 22a to said electronic control unit 10. The first connection branch 32 extends transversely in contact with the second portions 28 of the connection components 24 disposed at the first longitudinal end 7 of the heating elements 4.

As shown in FIG. 3, the first connection branch 32 is in contact with the connection components 24 of the first plates 22a of all of the heating elements 4. The first connection branch 32 thus electrically connects the connection components 24 of all of the first plates 22a of the heating elements 4 to the electronic control unit 10.

According to the invention, the connection assembly 30 comprises a second connection branch 34 extending between the electronic control unit 10 and the first longitudinal ends 7 of the heating elements 4 parallel to the first connection branch 32. The second connection branch 34 here extends parallel to and separately from the first connection branch 32, as is shown notably in FIG. 3. This second connection branch 34 is advantageously in contact with the connection components 24 of the second plates 22b to the electronic control unit 10. Even more advantageously, the second connection branch 34 is in contact with the connection components 24 of the second plates 22b of all of the heating elements 4.

The other aforementioned connection branch here consists of a third connection branch 36 including a first portion 40 extending from the electronic control unit 10 along one of the heating elements 4, between this heating element and a side wall 8 of the support 6 of the heating body, to the second longitudinal end 9 of the heating elements 4, and a second portion 42 extending parallel to the first connection branch 32 and facing the second longitudinal end 9 of at least one of the heating elements 4. In other words, the first portion 40 of the third connection branch 36 extends substantially in a direction parallel to the longitudinal direction L from the connection end piece 38 to at least the second longitudinal end 9 of the heating elements 4, the second portion 42 of the third connection branch 36 extending in a transverse direction T in contact with the connection components 24 of the third plates 22c of the heating elements 4. Advantageously, the third connection branch 36, and more specifically the second portion 42 thereof, is in contact with the connection components 24 of the third plates 22c of all of the heating elements 4.

The third connection branch 36 is configured to electrically connect the connection components 24 of the third plates 22c to the electronic control unit 10. In this configuration, the electronic control unit 10 transmits control instructions to the third plates 22c of the heating elements 4 via the third connection branch 36.

The connection assembly 30 thus enables the electronic control unit 10 to be connected electrically to the connection components 24 of the first plates 22a via the first connection branch 32, to the connection components 24 of the second plates 22b via the second connection branch 34, and to the connection components 24 of the third plates 22c via the third connection branch 36.

These electrical connections optimize the transmission of the control instructions transmitted by the electronic control unit 10 to the plates 20 of the heating elements 4, notably enabling at least two heating zones to be created through the heating body 2 by supplying power to the second connection branch 34 and/or to the third connection branch 36. This is because supplying power to the second plate 22b via the second connection branch 34 heats only the resistive elements 12 disposed between the second plate 22b and the first plate 22a. Similarly, supplying power to the third plate 22c via the third connection branch 36 heats the resistive elements 12 disposed between the third plate 22c and the first plate 22a. Selectively controlling the power supply to the second and third plates 22b, 22c makes it possible to delimit a first heating zone, defined by the zone containing the second plates 22b, and a second heating zone, defined by the zone containing the third plates 22c.

Furthermore, simultaneously powering the second and third plates 22b, 22c heats all of the resistive elements 12, i.e. the two heating zones simultaneously transfer calories to the air flow circulating through the heating body 2.

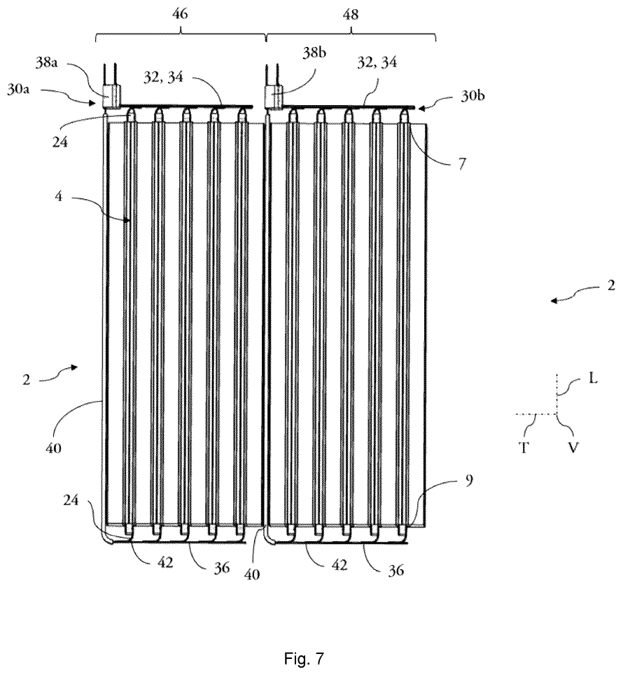

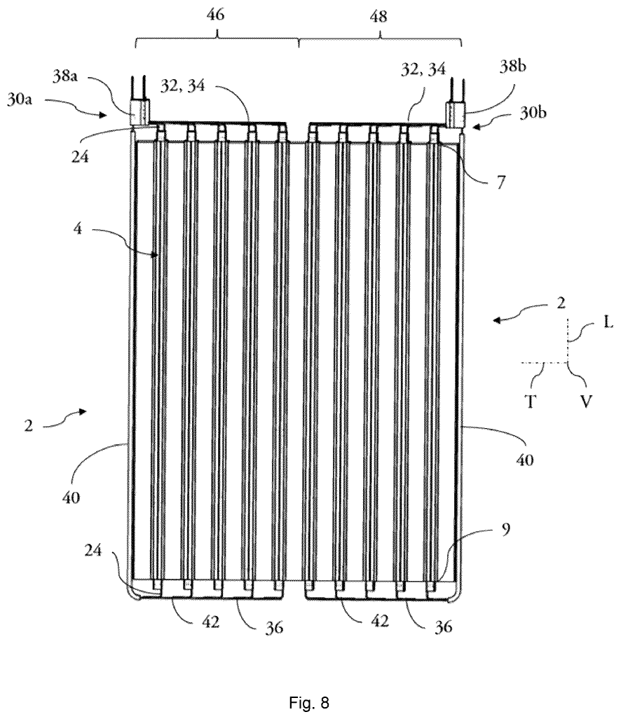

According to another alternative embodiment of the invention to the embodiment described above and shown in FIG. 7 or 8, the heating elements 4 are split into at least two heating assemblies 46, 48, the electric radiator 1 comprising a connection assembly 30a, 30b for each of the heating assemblies 46, 48. According to the example illustrated here, there is a first heating assembly 46 electrically connected to the electronic control unit 10 by a first connection assembly 30a and a second heating assembly 48 electrically connected to the electronic control unit 10 by a second connection assembly 30b. The connection assemblies 30a, 30b are independent of one another, i.e. the control instructions transmitted by the electronic control unit 10 are sent to one or other of the heating assemblies 46 via one or other of the connection assemblies 30a, 30b without being transmitted to the other heating assembly 46.

Each connection assembly 30a, 30b comprises a first connection branch 32, a second connection branch 34 and a third connection branch 36 as described above and a connection end piece 38 cooperating with the three connection branches 32, 34, 36 to electrically connect said connection branches 32, 34, 36 to the electronic control unit 10. The electronic control unit 10 thus transmits a control instruction to the first heating assembly 46 via the first connection assembly 30a, without transmitting this control instruction to the second heating assembly 48.

The electric radiator 1 thus comprises a first connection end piece 38a connected electrically to the electronic control unit 10 and to three connection branches 32, 34, 36, and a second connection end piece 38b also connected electrically to the electronic control unit 10 and to three connection branches 32, 34, 36 distinct from the connection branches 32, 34, 36 connected to the first connection end piece 38a.

More specifically, a first connection branch 32 of a first connection assembly 30a extends between the electronic control unit 10 and the first longitudinal ends 7 of the heating elements 4 of the first heating assembly 46, the first connection branch 32 extending parallel to the transverse direction T. The first connection branch 32 of the first connection assembly 30a is also in contact with the connection components 24 of the first plates 22a of the heating elements 4 of the first heating assembly 46. The first connection branch 32 of the first connection assembly 30a is advantageously in contact with the connection components 24 of the first plates 22a of all of the heating elements 4 of the first heating assembly 46.

A second connection branch 34 of the first connection assembly 30a extends between the electronic control unit 10 and the first longitudinal ends 7 of the heating elements 4 of the first heating assembly 46, the second connection branch 34 extending parallel to the transverse direction T and to the first connection branch 32 of the first connection assembly 30a. The second connection branch 34 of the first connection assembly 30a is also in contact with the connection components 24 of the second plates 22b of the heating elements 4 of the first heating assembly 46. The second connection branch 34 of the first connection assembly 30a is advantageously in contact with the connection components 24 of the second plates 22b of all of the heating elements 4 of the first heating assembly 46.

A third connection branch 36 of the first connection assembly 30a comprises a first portion 40 extending from the electronic control unit 10 along one of the heating elements 4 of the first heating assembly 46 to the second longitudinal end 9 of the heating elements 4, and a second portion 42 extending parallel to the first connection branch 32 and facing the second longitudinal ends 9 of the heating elements 4 of the first heating assembly 46. In other words, the first portion 40 of the third connection branch 36 extends substantially in a direction parallel to the longitudinal direction L from the first connection end piece 38a to at least the second longitudinal end 9 of one of the heating elements 4 of the first heating assembly 46, the second portion 42 of the third connection branch 36 of the first connection assembly 30a extending in a transverse direction T in contact with the connection components 24 of the third plates 22c of the heating elements 4 of the first heating assembly 46. Advantageously, the third connection branch 36 of the first connection assembly 30a, and more specifically the second portion 42 thereof, is in contact with the connection components 24 of the third plates 22c of all of the heating elements 4 of the first heating assembly 46.

The third connection branch 36 of the first connection assembly 30a is configured to electrically connect the connection components 24 of the third plates 22c of the heating elements 4 of the first heating assembly 46 to the electronic control unit 10. In this configuration, the electronic control unit 10 transmits control instructions to the third plates 22c of the heating elements 4 of the first heating assembly 46 via the third connection branch 36 of the first connection assembly 30a.

Similarly to the first connection assembly 30a, as described above, a first connection branch 32 of a second connection assembly 30b extends between the electronic control unit 10 and the first longitudinal ends 7 of the heating elements 4 of the second heating assembly 48, the first connection branch 32 extending parallel to the transverse direction T. The first connection branch 32 of the second connection assembly 30b is also in contact with the connection components 24 of the first plates 22a of the heating elements 4 of the second heating assembly 48. The first connection branch 32 of the second connection assembly 30b is advantageously in contact with the connection components 24 of the first plates 22a of all of the heating elements 4 of the second heating assembly 48.

A second connection branch 34 of a second connection assembly 30b extends between the electronic control unit 10 and the first longitudinal ends 7 of the heating elements 4 of the second heating assembly 48, the second connection branch 34 extending parallel to the transverse direction T and to the first connection branch 32 of the second connection assembly 30b. The second connection branch 34 of the second connection assembly 30b is also in contact with the connection components 24 of the second plates 22b of the heating elements 4 of the second heating assembly 48. The second connection branch 34 of the second connection assembly 30b is advantageously in contact with the connection components 24 of the second plates 22b of all of the heating elements 4 of the second heating assembly 48.

A third connection branch 36 of the second connection assembly 30b comprises a first portion 40 extending from the electronic control unit 10 along one of the heating elements 4 of the second heating assembly 48 to the second longitudinal end 9 of the heating elements 4 of the second heating assembly 48, and a second portion 42 extending parallel to the first connection branch 32 and facing the second longitudinal ends 9 of one of the heating elements 4 of the second heating assembly 48. In other words, the first portion 40 of the third connection branch 36 of the second connection assembly 30b extends substantially in a direction parallel to the longitudinal direction L from the second connection end piece 38b to at least the second longitudinal end 9 of the heating elements 4 of the second heating assembly 48, the second portion 42 of the third connection branch 36 of the second connection assembly 30b extending in a transverse direction T via the connection components 24 of the third plates 22c of the heating elements 4 of the second heating assembly 48. Advantageously, the third connection branch 36 of the second connection assembly 30b, and more specifically the second portion 42 thereof, is in contact with the connection components 24 of the third plates 22c of all of the heating elements 4 of the second heating assembly 48.

The third connection branch 36 of the second connection assembly 30b is configured to electrically connect the connection components 24 of the third plates 22c of the heating elements 4 of the second heating assembly 48 to the electronic control unit 10. In this configuration, the electronic control unit 10 transmits control instructions to the third plates 22c of the heating elements 4 of the second heating assembly 48 via the third connection branch 36 of the second connection assembly 30b.

According to a first example embodiment illustrated in FIG. 7, the first portion 40 of the third connection branch 36 of the first connection assembly 30a extends along one of the heating elements 4 participating in delimiting a transverse end of the heating body 2. More specifically, the first portion 40 of the third connection branch 36 of the first connection assembly 30a extends along an outer face of a heating element 4 of the first heating assembly 46, facing a side wall 8 of the support 6.

The first portion 40 of the third connection branch 36 of the second connection assembly 30b extends between two heating elements 4 of the heating body 2. More specifically, the first portion 40 of the third connection branch 36 of the second connection assembly 30b extends between a heating element 4 of the first heating assembly 46.

According to a second example embodiment illustrated in FIG. 8, the first portion 40 of the third connection branch 36 of the first connection assembly 30a extends along one of the heating elements 4 participating in delimiting a transverse end of the heating body 2. More specifically, the first portion 40 of the third connection branch 36 of the first connection assembly 30a extends along an outer face of a heating element 4 of the first heating assembly 46, facing a side wall 8 of the support 6.

Unlike the first example embodiment described above, the first portion 40 of the third connection branch 36 of the second connection assembly 30b extends along one of the heating elements 4 participating in delimiting a transverse end of the heating body 2, and more specifically along an outer face of a heating element 4 of the second heating assembly 48, facing the side wall 8 of the support 6 opposite the aforementioned side wall for the first connection assembly 30a.

Such careful positioning of the first portions 40 of the third connection branches 38 of the connection assemblies 30a, 30b optimizes the space occupied by the connection assemblies 30a, 30b, either through the heating body 2 or in relation to the space occupied on a printed circuit board of the electronic control unit 10.

Furthermore, this division into two heating assemblies 46, 48 enables the number of possible heating zones to be subdivided. This is because, in addition to the two heating zones mentioned above with reference to the second and third plates 22b, 22c, two new heating zones can be defined: a heating zone corresponding to the first heating assembly 46 and another heating zone corresponding to the second heating assembly 48. This means that there are four heating zones in such an electric radiator 1: a first heating zone delimited by the second plates 22b of the first heating assembly 46; a second heating zone delimited by the third plates 22c of the first heating assembly 46; a third heating zone defined by the second plates 22b of the second heating assembly 48; and a fourth heating zone defined by the third plates 22c of the second heating assembly 48. Each of the aforementioned zones can be activated independently from the others by the electronic control unit 10 and/or simultaneously.

To reiterate, the invention relates to an electric radiator in which the heating body has at least two independent heating zones, i.e. either one of the heating zones can be activated on its own or simultaneously with the other heating zone. The careful arrangement of the connection components of the plates of the heating elements at each of the longitudinal ends of the heating elements achieves the objective set, specifically to create at least two heating zones that can heat an air flow independently of one another.

The present invention is not however limited to the means and configurations described and illustrated in the present document, and also extends to all equivalent means and configurations and to any technically operational combination of such means.

What is claimed is:

1. An electric radiator for a heating, ventilation and/or air-conditioning system, the electric radiator comprising at least one heating body fitted with at least one heating element, at least one electronic control unit configured to power and control the operation of the at least one heating element and a housing in which the at least one electronic control unit is seated, the at least one heating body being fastened to the housing, the housing including a back wall facing the at least one heating body extending in a main plane of extension, the at least one heating element of the at least one heating body extending perpendicularly to the main plane of extension of the back wall and principally in a longitudinal direction having a first longitudinal end facing the at least one electronic control unit and an opposite second longitudinal end, the at least one heating element including several resistive elements and plates forming electrodes, the resistive elements being framed by the plates, wherein each plate of the at least one heating element is configured to have a connection component at one longitudinal end of the at least one heating element for the electrical connection of said plate to the at least one electronic control unit, at least one of these connection components being disposed at each of the longitudinal ends of this heating element.

2. The electric radiator as claimed in claim 1, wherein the at least one heating element includes at least a first plate that extends over the entire length of the at least one heating element, the at least one heating element including a second plate and a third plate each extending over a portion of the at least one heating element and being disposed on the other side of the resistive elements in relation to the first plate, the connection component of the second plate extending at one of longitudinal ends of the at least one heating element whereas the connection component of the third plate extends at the other of longitudinal ends of the at least one heating element.

3. The electric radiator as claimed in claim 2, wherein the connection component of the second plate is disposed at a first longitudinal end of the at least one heating element, the connection component of the third plate being disposed at a second longitudinal end of the at least one heating element.

4. The electric radiator as claimed in claim 2, wherein the connection component of the first plate and the connection component of the second plate are disposed at the same longitudinal end of the at least one heating element.

5. The electric radiator as claimed in claim 1, further comprising at least one connection assembly configured to electrically connect at least one connection component of a plate of the several plates to the at least one electronic control unit, the at least one connection assembly including at least a first connection branch extending parallel to the back wall of the housing and facing a first longitudinal end of at least one heating element and at least one other connection branch extending parallel to the back wall of the housing and facing a second longitudinal end of at least one heating element.

6. The electric radiator as claimed in claim 5, wherein the at least one heating element includes at least a first plate that extends over the entire length of the at least one heating element, the at least one heating element including a second plate and a third plate each extending over a portion of the at least one heating element and being disposed on the other side of the resistive elements in relation to the first plate, the connection component of the second plate extending at one of the longitudinal ends of the at least one heating element whereas the connection component of the third plate extends at the other of the longitudinal ends of the at least one heating element, wherein the at least one first connection branch is disposed between the at least one electronic control unit and the first longitudinal end of the at least one heating element and is configured to electrically connect the at least one connection component of the first plates to said at least one electronic control unit.

7. The electric radiator as claimed in claim 5, wherein the at least one heating element includes at least a first plate that extends over the entire length of the at least one heating element, the at least one heating element including a second plate and a third plate each extending over a portion of the at least one heating element and being disposed on the other side of the resistive elements in relation to the first plate, the connection component of the second plate extending at one of the longitudinal ends of the at least one heating element whereas the connection component of the third plate extends at the other of the longitudinal ends of the at least one heating element, wherein the at least one connection assembly includes a second connection branch extending between the at least one electronic control unit and the first longitudinal end of the at least one heating element parallel to the at least one first connection branch, the second connection branch being configured to electrically connect the connection components of the second plates to the at least one electronic control unit.

8. The electric radiator as claimed in claim 5, wherein the at least one heating element includes at least a first plate that extends over the entire length of the at least one heating element, the at least one heating element including a second plate and a third plate each extending over a portion of the at least one heating element and being disposed on the other side of the resistive elements in relation to the first plate, the connection component of the second plate extending at one of the longitudinal ends of the at least one heating element whereas the connection component of the third plate extends at the other of the longitudinal ends of the at least one heating element, wherein the at least one other connection branch consists of a third connection branch including a first portion extending from the at least one electronic control unit, parallel to the at least one heating element, to the second longitudinal end of the heating element and a second portion extending parallel to the at least one first connection branch and facing the second longitudinal end of one of the heating elements to electrically connect the connection components of the third plates to the at least one electronic control unit.

9. The electric radiator as claimed in claim 1, wherein the at least one heating element is split into at least two heating assemblies, with the electric radiator further comprising a connection assembly for each of the heating assemblies.

10. The electric radiator as claimed in claim 1, wherein the at least one heating element includes at least a first plate that extends over a first portion of the at least one heating element, the at least one heating element including a second plate and a third plate each extending over a second portion of the at least one heating element, the at least one heating element comprising including a fourth plate that extends over the first portion parallel to the first plate, each plate being distinct from the other plates, the connection components of the first plate and of the second plate extending at one of the longitudinal ends of the at least one heating element whereas the connection components of the third plate and of the fourth plate extend at the other of the longitudinal ends of the at least one heating element.

11. A heating, ventilation, and/or air-conditioning system, comprising at least one ventilation device able to force an air flow to circulate through the heating, ventilation, and/or air-conditioning system and an electric radiator, through which the air flow is heated, the electric radiator including at least one heating body fitted with at least one heating element, at least one electronic control unit configured to power and control the operation of the at least one heating element and a housing in which the at least one electronic control unit is seated, the at least one heating body being fastened to the housing, the housing including a back wall facing the at least one heating body extending in a main plane of extension, the at least one heating element of the at least one heating body extending perpendicularly to the main plane of extension of the back wall and principally in a longitudinal direction having a first longitudinal end facing the at least one electronic control unit and an opposite second longitudinal end, the at least one heating element including several resistive elements and plates forming electrodes, the resistive elements being framed by the plates, wherein each plate of the at least one heating element is configured to have a connection component at one longitudinal end of the at least one heating element for the electrical connection of mid e at least one electronic control unit, at least one of there connection components being disposed at each of the longitudinal ends of this heating element.
